(19) United States
(12) Patent Application Publication
(10) Pub. No.: US 2026/0257083 A1
(43) Pub. Date: Sep. 3, 2026

(54) BREATHING APPARATUS AND A METHOD OF CONTROLLING THE BREATHING APPARATUS

(71) Applicant: MALINA - SAFETY S.R.O., Jablonec nad Nisou (CZ)

(72) Inventor: Radek MALINA, Zizkov (CZ)

(21) Appl. No.: 18/846,622

(22) PCT Filed: Feb. 27, 2023
(86) PCT No.: PCT/CZ2023/050009

§ 371 Date: Sep. 12, 2024

(30) Foreign Application Priority Data
Mar. 14, 2022 (CZ) PV 2022-115

(51) Int. Cl. A62B 7/04; A62B 9/04; A62B 18/00; A62B 18/02; A62B 18/10

(52) U.S. Cl. CPC A62B 7/04; A62B 9/04; A62B 18/006; A62B 18/025; A62B 18/10

(57) ABSTRACT

A self-contained breathing apparatus with a demand valve at an outlet, a filter-ventilation unit, a fan, and a head unit with an inner space for pressure-separated breathing of the user from the surrounding environment and a one-way exhalation valve, wherein the self-contained breathing apparatus and the filter-ventilation unit are fluidly connected to the inner space of the head unit. The filter-ventilation unit generates stream (S₂) of filtered air, whose pressure (p₁₅) at the outlet of the self-contained breathing apparatus is greater than the value of the switching pressure (p_{S}) of the demand valve. The demand valve is provided with means for automatic opening the inlet of the autonomous breathing gas when the pressure (p₁₅) of the stream of the filtered air (S₂) at the outlet of the self-contained breathing apparatus drops below the value of the switching pressure (p_{S}) of the demand valve.

### TECHNICAL FIELD

The invention relates to a breathing apparatus comprising a self-contained breathing apparatus with a demand valve at the outlet, a filter-ventilation unit s with at least one air filter and a fan, and further comprising a head unit with an inner space for compressed air breathing of the user separated from the surrounding environment and with a one-way exhalation valve, wherein the self-contained breathing apparatus and the filter-ventilation unit are fluidly connected to the inner space of the head unit.

The invention further relates to a method of controlling the breathing apparatus, in which the cooperation of the self-contained breathing apparatus and the filter-ventilation unit towards the inner space of the head unit is controlled, wherein a stream of autonomous breathing gas is fed into the inner space of the head unit in a controlled manner by the self-contained breathing apparatus and a steady stream of the filtered air is fed into the inner space of the head unit with the filter-ventilation unit, the two streams being fed together to generate a breath-in stream of the breathing gas/air in the inner space of the head unit.

### BACKGROUND ART

Fire brigades use two fundamentally different types of breathing apparatus in their work to protect the firefighters.

The first type is a breathing apparatus with a supply of compressed breathing gas, e.g., an open circuit compressed air apparatus with a full face mask according to the EN 137 standard, or a lung governed demand self-contained open-circuit compressed air breathing apparatus with a full face mask or mouthpiece for escape according to the EN 402 standard. Usually, these devices are called Self-Contained Breathing Apparatus, or hereinafter only “SCBA”.

The second type is an powered filtering device with auxiliary ventilation according to EN 12941 or EN 12942, in English usually referred to as a powered air purifying respirator, hereinafter also only “PAPR”.

The SCBA comprises an autonomous tank of compressed breathing gas, e.g., air, which is connected to the inlet of the breathing gas to a head unit. The inlet of the breathing gas to the head unit is usually provided with at least one shut-off control valve to reduce the pressure of the breathing gas from the tank and is also provided with a demand valve, which is adapted to let the breathing gas into the inner space of the head unit depending on the course of the user's breathing, i.e., depending on the repetition of breathing in and beathing out and the related flow and pressure changes of the breathing gas at the outlet of the demand valve and in the inner space of the head unit. The demand valve and the inner space of the head unit are fluidly interconnected. The head unit comprises an inlet one-way valve which is connected to a breathing gas inlet and which is adapted to limit the internal volume of the head unit which defines the size of the breathing zone of the user and from which the breathing gas is breathed in into the lungs by the user and into which the gas is exhaled from the lungs by the user. The head unit further comprises an exhalation one-way valve for the removal of the breathing gas exhaled by the user from the respiratory system outside the head unit. According to some examples of the background art, the head unit is designed as a face mask, in which an inner mask is arranged into which both the above-mentioned valves open, i.e., the inlet one-way valve and the exhalation valve. The inner mask again serves to reduce the size of the internal volume of the head unit into which the breathing gas is supplied and exhaled. The demand valve, such as the demand valve according to U.S. Pat. No. 4,796,619A or another suitable demand valve, is configured to open and close at a required value of the breathing gas pressure in the user's breathing zone, this set value being higher than the ambient air pressure for safety reasons. When taking a breath in of the breathing gas, the pressure of the breathing gas at the outlet of the demand valve is reduced below the set value of a switching pressure, thereby temporarily opening the demand valve and allowing autonomous compressed breathing gas to flow from the tank through the control valve into the head unit and preventing the pressure from dropping relative to the surrounding environment. When the user breathes out or stops breathing, the breathing gas pressure at the outlet of the demand valve rises again above the set value of the switching pressure of the demand valve, as a result of which the demand valve closes and the breathing gas is no longer supplied to the head unit until the start of the user's next breath.

The disadvantage of the SCBA is mainly the limited supply of compressed breathing gas, which is usually sufficient for 30 to 45 minutes of breathing. A larger supply of compressed breathing gas then represents excess weight that the user would have to carry while using the SCBA, which is unacceptable.

A “PAPR” works in such a manner that the air from the vicinity of the apparatus is drawn in through a filter by the action of a fan and the filtered air is further transported to the head unit by the fan. The filtered air is supplied to the head unit at a pressure higher than the pressure of the air in the vicinity of the apparatus, by which means, in addition to supplying a person with filtered and therefore safe air for breathing, unwanted penetration of unfiltered air from the surrounding environment into the head unit and into the user's respiratory system is prevented. The filter is usually located at the air inlet of the apparatus. From the head unit, excess filtered air, together with the air exhaled by the user, is removed through the exhalation valve. The power of the fan is usually adjustable, for example, by controlling the operation of the drive motor of the fan, so that the user can control the amount of the filtered air flow through the head unit.

The disadvantage of the PAPR is that in principle it cannot be used where the oxygen content in the surrounding environment is lower than 17%, e.g., when burning in a closed room, in mining areas with reduced oxygen content, etc., since this would lead to an oxygen deficit of the user, subsequent loss of consciousness and suffocation of the user from lack of oxygen. On the contrary, in an environment with sufficient oxygen level in ambient air, the PAPR provides a long-duration supply of the user with filtered and safe breathing gas. Another disadvantage of the PAPR is the usual flow of the filtered air through the head unit may be momentarily (immediately) insufficient during extreme physical exertion of the user and the associated extreme breathing needs of the user, when the user breathes in a large volume of the filtered air in a short time with a quick and deep breath or quick and deep repeated breaths. When such a situation occurs, the risk of sudden consumption of the entire flow of the filtered air increases, which may lead not only to an oxygen deficit of the user, but there is also the risk of a short-term drop in the pressure of the filtered air in the head unit below the value of the pressure of the ambient air, as a result of which dangerous unfiltered air from the surrounding environment may penetrate into the user's breathing zone.

US2004182394A1 describes a device containing both a self-contained breathing apparatus (SCBA) and a powered air purifying respirator (PAPR), which are interconnected to form a combined positive pressure breathing apparatus having a single head unit with two inlets of breathing air. In one embodiment, the SCBA and the PAPR have their air outlets connected directly to the head unit via one-way air valves. In a second embodiment, the SCBA and the PAPR are connected by their air outlets via one-way air valves to an air merger, which is then connected to the head unit by one of its outlets, where another supply one-way air valve is arranged in the inlet to the head unit. In the first example of use of this apparatus according to US2004182394A1, the user only breathes isolated breathing gas from the SCBA apparatus from a compressed air bottle. In the second example of use of this apparatus, the user breathes only filtered ambient air from the PAPR. Between these two uses, or operating modes, it is then switched according to the current need, either manually by the user or automatically by the control system. When switching between these operating modes, either the SCBA is activated and the PAPR is turned off at the same time, or the SCBA is turned off and the PAPR is turned on at the same time.

The disadvantage of the solution according to US2004182394A1 is that at each change of operating mode, in particular when the battery source of the PAPR drive is exhausted or when the supply of compressed breathing gas in the SCBA is exhausted, the above-mentioned switching must be performed either manually by the user or automatically by the control system, which increases the risk of errors and malfunctions, because the user may be under great stress and physical strain while using the apparatus, and manual switching makes high demands on the user's attention. Alternatively, the breathing apparatus must be provided with a sufficiently durable and reliable, and therefore expensive, control system with sensing and power elements to perform automatic switching.

US2005051169A1 discloses a changeover valve for a breathing apparatus with a dual air source, which comprises a hollow body with two inlets and one outlet, the hollow body having a movable flap valve driven by an actuator which can be controlled by manipulating a high-pressure shut-off control valve of the tank of the SCBA or by manipulating the switch of a PAPR, either mechanically or electrically. The disadvantage of the apparatus provided with such a merging valve is that each time the user switches between the air sources, he has to perform several actions, such as closing/opening the shut-off valve of the SCBA and simultaneously switching on/off the operation of the PAPR, etc.

The common disadvantage of the devices according to US2004182394A1 and US2005051169A1 is the fact that during the operation of the PAPR, when the SCBA is switched off, there is a risk, due to rapid and deep breathing of the user, caused by panic, of a sudden drop in pressure and quantity of breathing air supplied to the head unit by the PAPR, which is associated not only with the danger of the penetration of harmful gases from the environment into the head unit and the user's lungs, but also with the danger of the user's oxygen deficiency.

The object of the invention is therefore to eliminate or at least reduce the disadvantages of the background art, especially the need for externally controlled switching from PAPR to SCBA operation, as well as the danger of the so-called “underbreathing” of the PAPR and other risks associated with the use and control of breathing apparatuses.

### SUMMARY OF INVENTION

The object of the invention is achieved by a breathing apparatus, whose principle consists in that a filter-ventilation unit is one-way fluidly coupled by its outlet to the inner space of a head unit, the filter-ventilation unit is one-way fluidly coupled to the outlet of the self-contained breathing apparatus, the self-contained breathing apparatus is fluidly coupled by its outlet to the inner space of the head unit, wherein the filter-ventilation unit is adapted to form a stream of the filtered air, the pressure of which at the outlet of the self-contained breathing apparatus is greater than the value of the switching pressure of the demand valve and at the same time the demand valve is adapted to automatically open the inlet of the autonomous breathing gas when the pressure of the stream of the filtered air at the outlet of the self-contained breathing apparatus falls below the value of the switching pressure of the demand valve.

The fan of the filter-ventilation unit is one-way pneumatically coupled to the outlet of the demand valve by its outlet, wherein the stream of the filtered air is adapted for normal breath in to fully supply the head unit with a breath-in stream of the breathing gas and to simultaneously close the inlet of a stream of autonomous breathing gas through the demand valve, and, in addition, the stream of the filtered air for extreme intake of breath is adapted to open the inlet of the stream of autonomous breathing gas through the demand valve and to supply the head unit with the breath in stream of the breathing gas formed by a mixture of a stream of the filtered air and a stream of autonomous breathing gas. The advantage of the breathing apparatus with the filter-ventilation unit fan which is one-way pneumatically coupled to the demand valve of an autonomous unit, is that it enables to control the supply of autonomous breathing gas from the demand valve to the head unit by turning on/off the fan operation with a switch of fan operation, without the user and/or the control system having to control other elements of the breathing apparatus at the same time. The fan is pneumatically unidirectionally coupled to the demand valve via the inlets of the filtered air and autonomous breathing gas to the head unit, so the apparatus does not need to be provided with additional lines for pneumatic control of the elements of the breathing apparatus. The stream of the filtered air which flows from the switched-on fan is adapted for normal breath in in to fully supply the head unit, and during normal breath in in the entire stream of the filtered air is usually not consumed by taking a breath, and with the apparatus according to the invention, the demand valve is still closed by the action of the pressure of the stream of the filtered air at the outlet of the self-contained breathing apparatus. For extreme or panic or otherwise excessive intake of breath which may be caused by a stress and/or increased strain, etc., of the user, the stream of the filtered air is partially adapted, i.e., it is adapted to partially supply the head unit. In fact, in the event of excessive intake of breath, the entire stream of the filtered air is rapidly consumed by the user, in which case due to the action of the apparatus according to the present invention, the pressure of the stream of the filtered air at the outlet of the self-contained breathing apparatus drops such that the demand valve opens and the stream of the filtered air is briefly supplemented with autonomous breathing gas. This prevents the pressure of the total stream of the breathing gas in the head unit from falling below the level of atmospheric air pressure in the vicinity of the breathing apparatus and reduces the risk of unfiltered air from the vicinity of the breathing apparatus entering the head unit. Another advantage is that such an arrangement of elements also allows the breathing apparatus to be used in an emergency mode with a malfunctioning autonomous and filter-ventilation unit, where the head unit is supplied only with a stream of the filtered air sucked in by the user's breath in from the surrounding environment via the filter-ventilation unit with the fan off or inoperative.

Preferred embodiments of the breathing apparatus are the subject of dependent patent claims.

A merging adapter serves to merge two separate inlets of the breathing gas/air streams into one common inlet of the total stream of the breathing gas/air into the head unit of the breathing apparatus. The inlet of the stream of the filtered air into the merging adapter is provided with an inlet one-way valve and is adapted for connection of the supply of the stream of the filtered air. The inlet of the stream of autonomous breathing gas to the merging adapter is adapted for connection of the inlet of the stream of autonomous breathing gas. The outlet of the breath in stream of the breathing gas from the merging adapter is adapted to connect the common inlet to the head unit.

The principle of the method of controlling the breathing apparatus consists in that a steady stream of the filtered air into the inner space of the head unit is used to maintain the outlet of the self-contained breathing apparatus closed during the operation of the filter-ventilation unit, the pressure of the steady stream of the filtered air at the outlet of the self-contained breathing apparatus being higher than the set switching pressure of the self-contained breathing apparatus, wherein when the pressure of the steady stream of the filtered air at the outlet of the self-contained breathing apparatus drops below the set switching pressure, the outlet of the self-contained breathing apparatus opens automatically and without user intervention, and the stream of autonomous breathing gas is momentarily connected to the stream of the filtered air in the inner space of the head unit, thereby creating autonomously and without user intervention a breath-in stream of the breathing gas/air from a mixture of both streams.

During the operation of the filter-ventilation unit, during a normal breath in of the user with a stream of the filtered air, the demand valve is closed by the stream of the filtered air and a breath-in stream of the breathing gas into the head unit is generated only by the stream of the filtered air, whereas when the user takes an extreme breath, a pressure drop of the stream of the filtered air is created at the outlet of the autonomous breathing gas from the demand valve, thereby reducing the pressure at the outlet of the demand valve below the set value of the switching pressure of the demand valve, thereby opening the demand valve and creating a breath-in stream of the breathing gas into the head unit by a mixture of the stream of the filtered air and the stream of autonomous breathing gas. This method of controlling the breathing apparatus saves the supply of autonomous breathing gas in the SCBA tank, increases the breathing comfort of the breathing apparatus user and prevents the penetration of unfiltered air from the surrounding environment into the breathing apparatus, while the breathing apparatus is controlled automatically without user intervention and without control by the control unit. This method of controlling the breathing apparatus saves the supply of autonomous breathing gas in the SCBA tank, increases the breathing comfort of the user of the breathing apparatus and prevents the penetration of unfiltered air from the surrounding environment into the breathing apparatus, while the breathing apparatus is controlled automatically without user intervention and without control by the control unit.

### BRIEF DESCRIPTION OF DRAWINGS

The invention is schematically illustrated in the drawings, wherein

FIG. 1 shows a breathing apparatus with the powered air purifying respirator (PAPR) on and the user breathing out,

FIG. 2 shows the breathing apparatus with the PAPR activated and when taking a normal breath in,

FIG. 3 shows the breathing apparatus with the PAPR activated and the self-contained breathing apparatus (SCBA) activated when taking an extreme breath,

FIG. 4 shows the breathing apparatus with the PAPR off and the SCBA on and when taking a breath in,

FIG. 5 shows the breathing apparatus with the PAPR off and the SCBA off and during resistance breathing through the PAPR filter,

FIG. 6 shows the breathing apparatus with a merging adapter and a head unit in the form of a half-mask,

FIG. 7 represents the breathing apparatus with a merging adapter and a head unit in the form of a face mask,

FIG. 8 shows the breathing apparatus with a merging adapter and a head unit in the form of a face mask with an inner mask,

FIG. 9 shows the breathing apparatus arranged in a protective suit with ambient air inlet passages to the PAPR filters,

FIG. 10 shows an example of embodiment of the merging adapter according to the invention and

FIGS. 11a to 11e show the course of the air pressure from the PAPR and/or the SCBA in the inner space (breathing zone) of the head unit according to the invention during the operation of the individual parts of the apparatus according to the invention and the mutual synergy of the effects of the individual elements of the apparatus according to the invention.

### EXAMPLES OF EMBODIMENT

The invention will be described with reference to exemplary embodiments of a combined breathing apparatus which comprises a self-contained breathing apparatus 1 for generating a stream S₁ of autonomous breathing gas and a filter-ventilation unit 2 for generating a stream S₂ of filtered ambient air. The self-contained breathing apparatus 1 is at its outlet 15 connected bidirectionally (freely) fluidly to the inner space 34 (breathing zone) of the head unit 3. The filter-ventilation unit 2 is at its outlet 25 connected fluidly unidirectionally to the inner space 34 (breathing zone) of the head unit 3.

The self-contained breathing apparatus 1, hereinafter the SCBA 1 (from the English term self-contained breathing apparatus =SCBA) comprises, for example, a self-contained open circuit compressed air breathing apparatus with a face mask according to the EN 137 standard, or a self-contained open-circuit compressed air breathing apparatus with automatic lung function and a face mask or mouthpiece according to the EN 402 standard, etc., or another suitable SCBA 1. The SCBA 1 comprises an autonomous tank 11 of the breathing gas, e.g., air, oxygen, a mixture of gases with a high oxygen content, etc. The autonomous tank 11 is fluidly connected by its gas outlet to the inlet of a shut-off control valve 12, which is fluidly connected by its outlet to the inlet 141 of a demand valve 14. In the exemplary embodiment shown, the shut-off control valve 12 is connected to the demand valve 14 by a hose 13, in an unillustrated exemplary embodiment by a pipe or directly, etc. In another unillustrated example of embodiment, a second shut-off control valve is connected between the shut-off control valve 12 and the demand valve 14, etc. The demand valve 14 is fluidly connected bidirectionally (freely) to the inner space 34 (breathing zone) of the head unit 3 by its outlet 142 of the breathing gas. The demand valve 14 is adapted to open the passage of the breathing gas from the SCBA 1 into the inner space 34 of the head unit 3 when the air pressure between its outlet 142 and the inner space 34 of the head unit 3 is lower than the set switching pressure p_{S} of the demand valve 14 and, in addition, the demand valve 14 is adapted to close the passage of the breathing gas from the SCBA 1 into the inner space 34 of the head unit 3 when the air pressure between its outlet 142 and the inner space 34 of the head unit 3 is higher than the set switching pressure p_{S} of the demand valve 14. The switching pressure p_{S} of the demand valve 14 is usually set to be higher than the atmospheric pressure in the surrounding environment of the breathing apparatus, and at the same time, it is set to be lower than the opening pressure p_{O38} of the exhalation valve 38. For example, according to standard EN 137, the switching pressure p_{S} of the demand valve 14 is a maximum of 500 Pa.

The filter-ventilation unit 2, hereinafter a PAPR 2 (from the English term “powered air purifying respirator” =PAPR) comprises, for example, a filter means with auxiliary ventilation according to EN 12941 standard or according to EN 12942 standard, etc., or comprises another suitable device for generating and supplying filtered air from the surrounding environment to the inner space 34 (breathing zone) of the head unit 3. The PAPR 2 comprises at least one air filter 21 at its air inlet to filter ambient air, e.g., an air filter 21 with a filter insert consisting of synthetic fibres and/or activated carbon and/or a catalyst and/or glass fibres, etc., or another suitable filter material or assembly of filter materials. Preferably, the filter 21 is made as non-wettable with water. The air filter 21 is connected by its air outlet to the inlet 221 to a fan 22, e.g., an electric fan 22 powered by batteries, or a fan 22 powered by a gas stream, or another suitable fan 22. The air outlet 222 of the fan is fluidly connected unidirectionally, for example here via the inlet 23 of the filtered air, e.g., by a supply hose, pipe, etc., etc., to the inner space 34 (breathing zone) of the head unit 3. A first supply one-way valve 5 is arranged between the outlet 222 of the fan and the inlet into the inner space 34 (breathing zone) of the head unit 3. The drive of the fan 22 is coupled to the control element of the operation of the fan 22, i.e., the control element of the PAPR 2. The control element of the PAPR 2 is, for example, formed by a manually controlled switch 24, in an unillustrated exemplary embodiment, it is formed by an automatically controlled switch coupled to a suitable unillustrated sensor of status variables, e.g., a sensor of the amount of oxygen in the surrounding environment, or the control element of the PAPR 2 is formed by another suitable element or device adapted to switch on/off the operation of the PAPR 2, i.e., for switching on/off the operation of the fan 22.

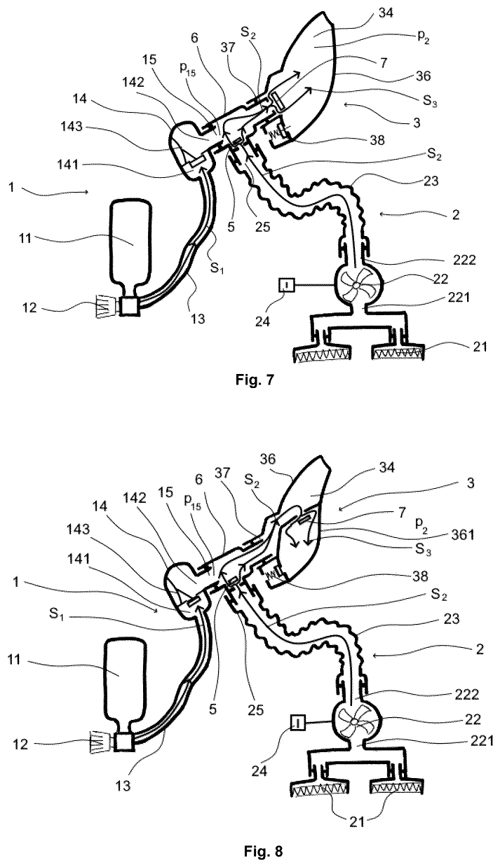

For example, the head unit 3 is formed by a half-mask 35 (FIG. 6), a face mask 36 (FIG. 7), a face mask 36 with an inner mask 361 (FIG. 8), or the head unit 3 is made up of a hood, a hood with a half-mask 35, etc. The head unit 3 is adapted to be placed on the user's head or on the part of the user's head around the user's airway entrance, etc. The head unit 3 is provided with the above-mentioned inner space 34 (breathing space), from which the user breathes in a breath-in stream S₃ of the breathing gas and into which the user exhales the breathing gas (air). The inner space 34 (breathing zone) is fluidly unidirectionally coupled to the surrounding environment through a one-way exhalation valve 38. The one-way exhalation valve 38 is designed to close when the pressure of the breathing gas in the inner space 34 of the head unit 3 drops below the set value of the pressure to protect the user from the risky penetration of ambient air through leaks, through the one-way exhalation valve 38, etc., from the surroundings of the head unit 3 into the inner space 34 of the head unit 3. The safe value of the pressure for closing the one-way exhalation valve 38, i.e. the closing pressure p_{Z38} of the one-way exhalation valve 38 is, in an exemplary embodiment, by 100 Pa up to 1000 Pa, ideally by 500 Pa to 600 Pa higher than the pressure of ambient air of the breathing apparatus, and at the same time, this safe value of the pressure is higher than the switching pressure p_{S} of the demand valve 14. Optionally, the head unit 3 is further provided with an unillustrated seal that forms a sealing line for sealing the circumference of the inner space 34 and the user's face from the surrounding environment.

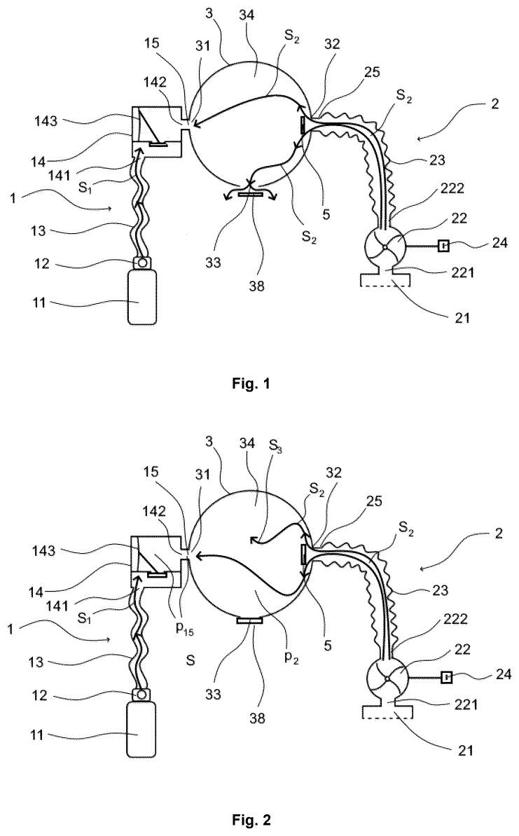

In the exemplary embodiments of FIGS. 1 to 5, the inner space 34 of the head unit 3 is provided with a first separate inlet 31, which is coupled bidirectionally (freely) fluidly to the outlet 15 of the SCBA 1, i.e., to the outlet of the autonomous breathing gas from the SCBA 1. The inner space 34 of the head unit 3 is further provided with a second separate inlet 32, which is fluidly unidirectionally coupled to the outlet 25 of the filtered air from the PAPR 2. The inner space 34 of the head unit 3 is further provided with a separate outlet 33 with a one-way exhalation valve 38, which is fluidly unidirectionally coupled to the surrounding environment. According to FIGS. 1 to 5, the first separate inlet 31 is substantially immediately connected to the outlet 142 of the demand valve 14 of the SCBA 1. According to FIGS. 1 to 5, the second separate inlet 32 is provided with a first inlet one-way valve 5, for example a valve with a cone and a seat or with a flap or a flexible membrane, etc.

In the exemplary embodiments of FIGS. 6 to 9, the inner space 34 of the head unit 3 is provided with a common inlet 37 which is connected to the outlet 63 of a merging adapter 6. The merging adaptor 6 comprises a hollow body 64 which is provided with a first inlet 61 for bidirectional (free) fluid coupling to the outlet 15 of the breathing gas from the SCBA 1. The hollow body 64 of the merging adapter 6 is further provided with a second inlet 62 for unidirectional fluid coupling to the outlet 25 of the filtered air from the PAPR 1. A first one-way supply valve 5 is situated in the second inlet 62 of the hollow body 64 of the merging adapter 6.

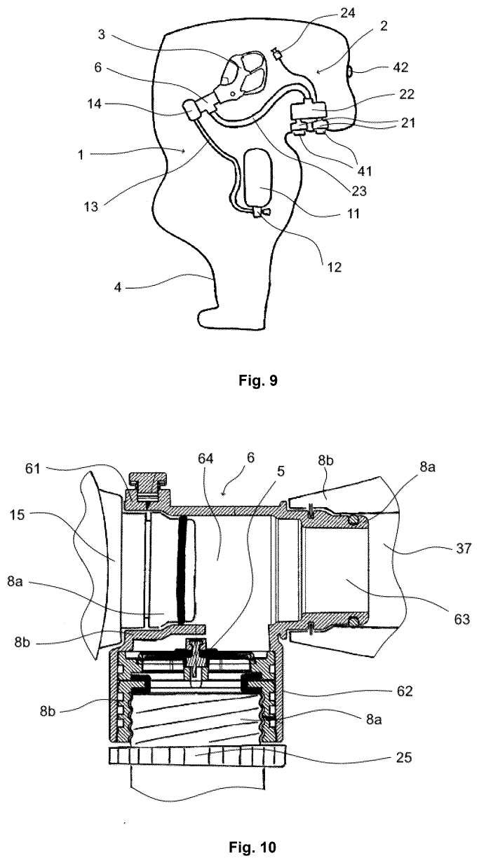

In the exemplary embodiment shown in FIG. 9, the SCBA 1, the PAPR 2 and the head unit 3 are arranged in the inner space of a protective suit 4, which is provided with at least one passage 41 for the fluid connection of the inlet of the air from the surrounding environment of the protective suit 4 to the air filter 21 of the PAPR 2. The protective suit 4 is also provided with a suitable one-way exhalation valve 42 for the safe coupling of the inner space of the protective suit 4 to the surrounding environment.

In the exemplary embodiment of FIGS. 6 to 8, a second one-way supply valve 7 the common inlet 37 of the inner space 34 of the head unit 3 is associated with the second one-way supply valve Z to prevent the entry of the exhaled breathing gas (air) from the inner space 34 of the head unit 3 into the inner space of the adapter 6. In an unillustrated embodiment, the common inlet 37 of the inner space 34 of the head unit 3 is made without the second inlet one-way valve 7.

In the exemplary embodiment of FIGS. 6 to 9, the emerging adapter 6 is formed to be detachable from the head unit 3, allowing the user, for example, easily and quickly convert a single-purpose SCBA 1 or a single-purpose PAPR 2 with a removable head unit 3 into a combined breathing apparatus according to the present invention and back again.

FIG. 10 shows an exemplary embodiment of the merging adapter 6, whose first inlet 61 is adapted for connection to the outlet 15 of the SCBA 1, here, for example, directly to the outlet 142 of the demand valve 14. The second inlet 62 of the merging adapter 6 is provided with the first one-way supply valve 5 and is adapted for the connection of the outlet 25 of the PAPR 2. The outlet 63 of the merging adapter 6 is adapted to connect to the common inlet 37 of the inner space 34 of the head unit 3. From the point of view of easy and universal connection of individual parts, one of the two connected parts is provided with the first part 8a of the connector 8 and the other of the two connected parts is provided with the second part 8b of the connecting connector 8, here, for example, with a tubular connector with a bayonet cap. In the exemplary embodiment shown in FIG. 10, the parts 8a, 8b of the connecting connectors 8 are formed as push-in tubular parts which are inserted into each other or as tubular parts which screw into each other. In an unillustrated exemplary embodiment, the connected elements are provided with other suitable connecting means, e.g., depending on the specific type of connectors on the SCBA 1 and the PAPR 2 and the head unit 3.

In another unillustrated example of embodiment, at least one extension, adapter, coupling, etc., is inserted between at least one input 61, 62 or outlet 63 of the merging adapter 6 and the connected part of the apparatus, according to the structural arrangement of the specific SCBA 1, the PAPR 2 and the head unit 3.

It follows from the above the individual elements and nodes of the apparatus according to the invention are assembled in such a manner that:
the filter-ventilation unit 2 is by its outlet 25 fluidly unidirectionally coupled to the inner space 34 of the head unit 3;
the filter-ventilation unit 2 is by its outlet 25 fluidly unidirectionally coupled to the outlet 15 of the self-contained breathing apparatus 1;
the self-contained breathing apparatus 1 is by its outlet 15 coupled fluidly to the inner space 34 of the head unit 3;
wherein the individual elements and nodes of the apparatus according to the invention are set such that:
the filter-ventilation unit 2 is adapted to create a stream S₂ of the filtered air, whose pressure p₁₅ at the outlet 15 of the self-contained breathing apparatus 1 is greater than the value of the switching pressure p_{S} of the demand valve 14,
and at the same time, the demand valve 14 is adapted to automatically open the supply of the autonomous breathing gas when the pressure p₁₅ of the stream S₂ of the filtered air at the outlet 15 of the self-contained breathing apparatus 1 falls below the switching pressure p_{S} of the demand valve 14.

In order to improve safety and security, the filter-ventilation unit 2 in a preferred example embodiment is also adapted to generate a stream S₂ of the filtered air whose pressure p₂ on the one-way exhalation valve 38 is greater than the value of the closing pressure p_{Z38} of the one-way exhalation valve 38, which allows to maintain overpressure in the inner space 34 of the head unit 3 to protect against unwanted penetration of unfiltered ambient air into the inner space 34 of the head unit 3.

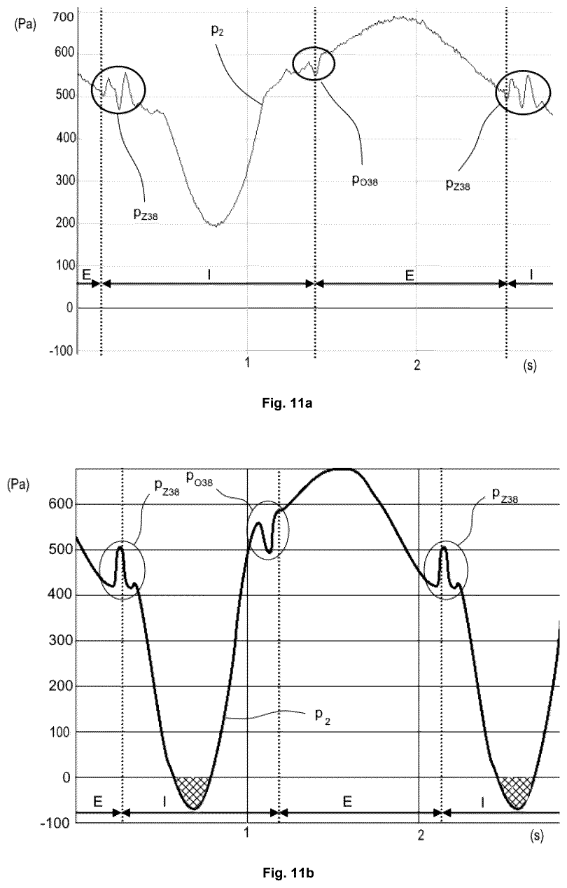

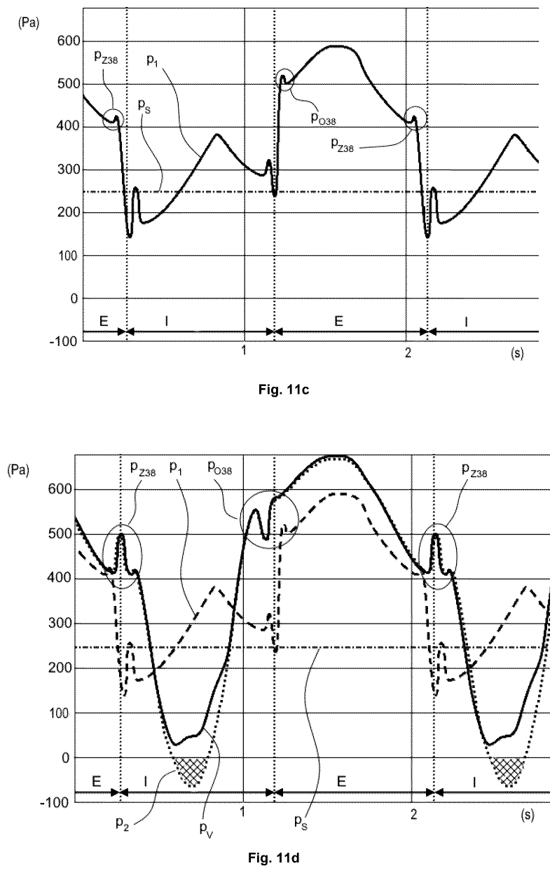

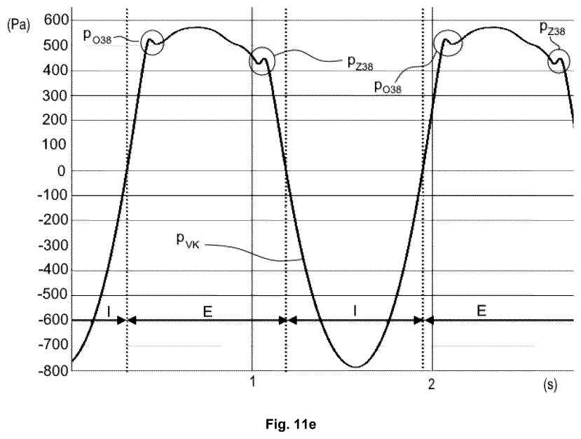

When the apparatus according to the invention is used for breathing the filtered air, i.e., when the user is breathing with the head unit 3 in place and the PAPR 2 running, the PAPR 2 generates at its outlet 25 a steady stream S₂ of the filtered air, i.e., the ambient air which has passed through the filter 21. This stream S₂ of the filtered air is delivered into the inner space 34 of the head unit 3 and at the same time it is delivered to the outlet 15 of the self-contained breathing apparatus 1, i.e., SCBA 1. If the stream S₂ of the filtered air is sufficient to cover the normal breathing needs of the user, due to the repeated consumption and replenishment of the filtered air in the inner space 34 of the head unit 3, the pressure p₂ of the filtered air in the inner space 34 of the head unit 3 repeatedly decreases and increases, as shown in FIG. 11a, which shows the time course of the pressure p₂ of the steady stream S₂ of the filtered air in the inner space 34 of the head unit 3 during the breathing of the user using only the PAPR 1, wherein the area I indicates the breath in area and the area E indicates the breath out area. The amount of the delivered filtered air is sufficient at every moment during breathing according to FIG. 11a, so that even at the moment of the greatest drop in the pressure of the filtered air, its pressure is still sufficient for breathing. However, if the user takes a deeper and faster breath, breathing with the PAPR 1 alone will also result in a deeper drop in the pressure p₂ of the filtered air, as shown in FIG. 11b, and there is a risk of insufficient filtered air for the user's immediate breathing needs, as shown by hatched area below the level “0” in FIG. 11b.

FIG. 11c shows the normal behaviour of the SCBA 1 itself, which delivers the stream S₁ of the autonomous breathing gas to the inner space 34 of the head unit 3, intermittently, depending on the time course of the pressure p₁ of the autonomous breathing gas in the inner space 34 of the head unit 3. When the user breathes in, see area I in FIG. 11c, first there is a drop in the pressure of the exhaled breathing gas in the inner space 34 of the head unit 3, which extends to the outlet 15 of the SCBA 1, e.g., to the control membrane 143 of the demand valve 14, which, after reaching the set value p_{S} of its switching pressure, opens and starts supplying the autonomous air to the inner space 34 of the head unit 3. The user continues to breathe in, while the pressure p₁ of the autonomous breathing gas in the inner space 34 of the head unit 3 slightly rises. This is followed by the end of breathing in and the beginning of breathing out, during which the pressure of the breathing gas in the inner space 34 of the head unit 3 increases until it exceeds the value of the switching pressure p_{S} of the demand valve 14, or the value of closing the supply of autonomous breathing gas to the inner space 34 of the head unit 3. Subsequently, the whole process is repeated.

By interconnecting the SCBA 1 and the PAPR 2 and their mutual adjustment according to the present invention, the apparatus according to the present invention behaves as shown in FIG. 11d, compared to the normal behaviour of the SCBA 1 alone and to the normal behaviour of the PAPR 2 alone. The main one-way supply valve 5 is kept open by the action of the stream S₂ of the filtered air, and the stream of the filtered air S₂ flows into the inner space 34 of the head unit 3, which covers the normal breathing needs of the user. Once the pressure in the inner space 34 of the head unit 3 has reached the opening pressure p_{O38} of the exhalation valve 38, the one-way exhalation valve 38 automatically opens and the excess filtered air, together with the unfiltered exhaled air, is discharged into the environment (FIG. 1). At the same time, the pressure p_{O38} is higher than the ambient atmospheric pressure to ensure the safety of the system against the penetration of unfiltered ambient air into the inner space 34 of the head unit 3.

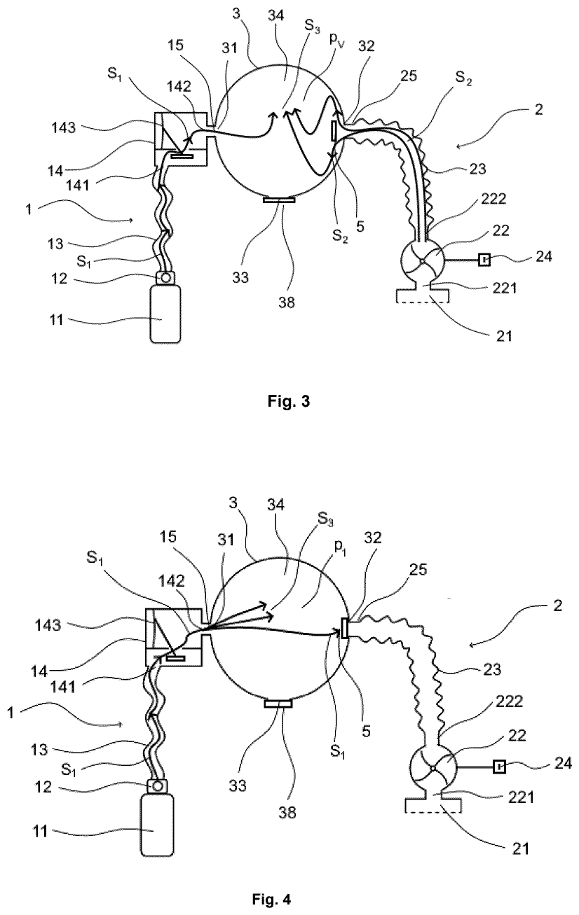

Simultaneously with the filling of the inner space 34 of the head unit 3 with the stream S₂ of the filtered air, the stream S₂ of the filtered air acts on the outlet 15 of the SCBA 1 and since its pressure p₁₅ at the outlet 15 of the SCBA 1 is greater than the switching pressure p_{S} of the SCBA 1 to open the demand valve 14, the stream S₂ of the filtered air keeps the inlet of the autonomous breathing gas into the inner space 34 of the head unit 3 closed (FIGS. 2, 6, 7, 8). If the resulting pressure p_{V} in the inner space 34 of the head unit 3 drops below the switching pressure value p_{S} of the SCBA 1 when the user taking a breath in, e.g. during panic or stress or other non-standard user breathing in, it will automatically and without any user intervention start the supply of the stream S₁ of the autonomous breathing gas into the inner space 34 of the head unit 3, whereby the autonomous breathing gas mixes with the filtered air and together they cover the immediate breathing needs of the user in the inner space 34 of the head unit 3, as shown in FIG. 11d and FIG. 3, so that the resulting pressure p_{V} in the inner space 34 of the head unit 3 does not fall below a critical limit endangering the health and safety of the user. At the end of the user breathing in and the beginning of breathing out, the pressure p_{V} in the inner space 34 of the head unit 3 increases again above the value of the switching pressure p_{S} of the SCBA 1 and the demand valve 14 closes and the inlet of the stream S₁ of the autonomous breathing gas to the inner space 34 of the head unit 3 is closed.

If the PAPR 2 fails to operate, for example due to exhaustion of energy for driving the fan 22, by turning off the PAPR 2 after detecting a lack of oxygen in the ambient air, exhaustion of the filtering capacity of the filter 21, pinching of the supply hose 13 of the filtered air, etc., the SCBA 1 is automatically and without user intervention put into operation in the manner described above and the protection of the life and health of the user is fully ensured (FIGS. 4 and 11c).

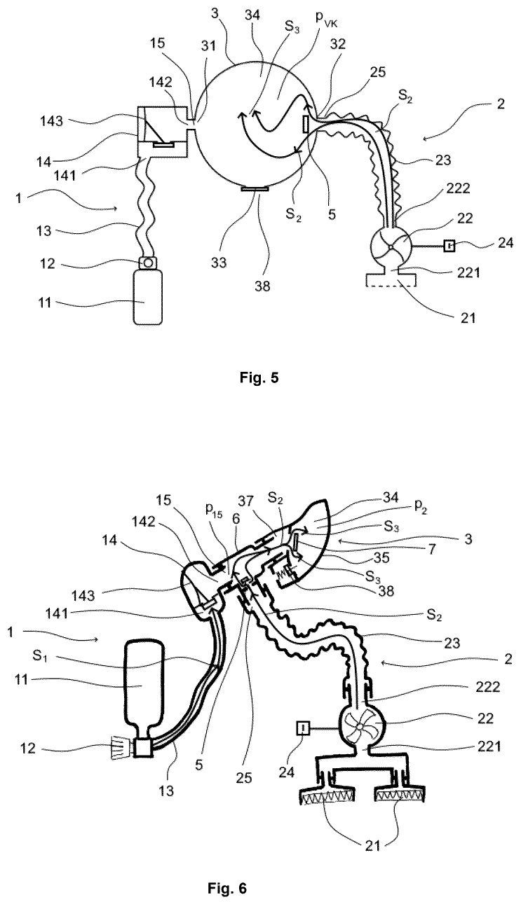

If there is a failure of the PAPR 2 and at the same time the supply of the autonomous breathing gas of the SCBA 1 is consumed, it is still possible to use resistance breathing of the user directly through the filter 21 of the PAPR 2 without the support of the fan 22, as shown in FIG. 11e in the form of the time course of the p_{VK} pressure in the inner space 34 of the head unit 3 with the SCBA 1 and the PAPR 2 turned off (FIGS. 5 and 11e).

If there is a failure of the PAPR 2 and at the same time the supply of autonomous breathing gas of the SCBA 1 is consumed, it is still possible to use resistance breathing of the user directly through the filter 21 of the PAPR 2 without the support of the fan 22, as shown in FIG. 11e in the form of the time course of the p_{VK} pressure in the inner space 34 of the head unit 3 with both the SCBA 1 and the PAPR 2 turned off (FIGS. 5 and 11e).

In the breathing apparatus according to the invention, the nominal flow rate of the filtered air from the PAPR 2 is adapted for use with a specific SCBA 1 and/or is adapted to national technical and safety standards and requirements, optionally it is adapted also to individual breathing parameters and needs of the particular user. For example, the nominal flow rate of the filtered air from the PAPR 2 is set to 100 litres per minute, 120 litres per minute, 140 litres per minute, 160 litres per minute, 180 litre per minute, 200 litres per minute, 220 litres per minute, etc. up to 250 litres per minute, 300 litres per minute, etc., according to current needs.

The breathing apparatus according to the present invention in all described embodiments and operating modes allows to extend the time of the user's stay in a risky environment, since it allows to save the supply of the autonomous breathing gas by the user's non-intervention (autonomous) connection of the SCBA 1 to the activated PAPR 2, and at the same time by simply turning off the PAPR 2, the SCBA 1 is connected again without user intervention (autonomously). Even after the supply of the autonomous breathing gas has been exhausted, the apparatus according to the invention allows user-free breathing directly through the filter 21 of the PAPR 2. The apparatus according to the invention is also adapted to maintain the pressure in the inner space 34 of the head unit 3 higher than the ambient air pressure, e.g., higher by up to 1000 Pa, ideally by 20 Pa to 300 Pa.

### LIST OF REFERENCES

1 self-contained breathing apparatus=SCBA
11 autonomous tank
12 shut-off control valve
13 hose
14 demand valve
141 inlet of the demand valve
142 outlet of the demand valve
143 control membrane
15 outlet of the self-contained breathing apparatus
2 filter-ventilation unit=PAPR
21 air filter
22 fan
22 air inlet of the fan
222 air outlet of the fan
23 inlet of the filtered air
24 manually operated switch
25 outlet of the filter-ventilation unit
3 head unit
31 first separate inlet
32 second separate inlet
33 outlet
34 inner space
35 half-mask
36 mask
361 inner mask
37 common inlet
38 one-way exhalation valve
4 protective clothing
41 passage
42 one-way exhalation valve of the protective clothing
5 first one-way supply valve
6 merging adapter
61 first inlet
62 second inlet
63 outlet
64 hollow body
7 second one-way supply valve
8 connector
8a first part of the connector
8b second part of the connector
S₁ stream of the autonomous breathing gas
S₂ stream of the filtered air
S₃ breath in stream of the breathing gas
p_{S} switching pressure of the SCBA=switching pressure of the demand valve
p_{Z38} closing pressure of the one-way exhalation valve
p_{O38} opening pressure of the one-way exhalation valve
p₁₅ pressure of the filtered air at the outlet of the self-contained breathing apparatus=pressure of the filtered air at the outlet of the demand valve
p₁ pressure of the autonomous breathing gas in the inner space of the head unit
p₂ pressure of a steady stream of the filtered air in the inner space of the head unit
p_{V} resulting pressure in the inner space of the head unit
p_{VK} resulting pressure in the inner space of the head unit with the SCBA and PAPR turned off
I breath-in area
E breath-out area

1. A breathing apparatus comprising a self-contained breathing apparatus with a demand valve at the outlet, a filter-ventilation unit with at least one air filter and a fan and further comprising a head unit with an inner space for pressure-separated breathing of the user from the surrounding environment and with a one-way exhalation valve, wherein the self-contained breathing apparatus and the filter-ventilation unit are fluidly connected to the inner space of the head unit, wherein
the filter-ventilation unit is by its outlet fluidly unidirectionally coupled to the inner space of the head unit and
the filter-ventilation unit is by its outlet fluidly unidirectionally coupled to the outlet of the self-contained breathing apparatus,
the self-contained breathing apparatus is by its outlet fluidly coupled to the inner space of the head unit;
wherein
the filter-ventilation unit is provided with means for generating a stream (S₂) of filtered air, whose pressure (p₁₅) at the outlet of the self-contained breathing apparatus (1) is greater that the value of the switching pressure (p_{S}) of the demand valve,
and, at the same time, the demand valve is provided with means for spontaneous automatic opening of the inlet of autonomous breathing gas when the pressure (p₁₅) of the stream (S₂) of the filtered air at the outlet (of the self-contained breathing apparatus drops below the value of the switching pressure (p_{S}) of the demand valve.

2. The breathing apparatus according to claim 1, wherein the filter-ventilation unit is further provided with means for generating a stream (S₂) of filtered air, whose pressure (p₂) on the one-way exhalation valve is greater than the value of the closing pressure (p_{Z38}) of the one-way exhalation valve.

3. The breathing apparatus according to claim 1, wherein the inner space of the head unit is connected to the inlet of a stream (S₁) of the autonomous breathing gas via a first separate inlet and is at the same time connected via a second separate inlet to the inlet of a steady stream (S₂) of the filtered air, wherein the inner space is by its separate outlet connected to the one-way exhalation valve and the first separate inlet is fluidly connected to the second separate inlet.

4. The breathing apparatus according to claim 1, wherein the inner space of the head unit is by a common inlet coupled to the outlet of a merging adapter, which is by its first inlet coupled to the outlet of the self-contained breathing apparatus and by its second inlet is coupled to the outlet of the filter-ventilation unit, wherein a first one-way supply valve is assigned to the second inlet.

5. The breathing apparatus according to claim 4, wherein in that the merging adapter is removable from the head unit.

6. The breathing apparatus according to claim wherein a second one-way supply valve is assigned to the common inlet of the inner space of the head unit.

7. The breathing apparatus according to claim 4, wherein the adapter comprises a hollow body which is provided with an inlet for connecting the self-contained breathing apparatus and the second inlet for connecting the filter-ventilation unit and is further provided with a common outlet, wherein the second inlet is provided with the one-way supply valve and both inlets and the common outlet are provided with a first part of the connector for connection to the surrounding elements.

8. The breathing apparatus according to claim 1, wherein the inner space of the head unit is formed by the inner space of a face mask or the inner space of a half-mask or the inner space of a quarter-mask or the inner space of a mouthpiece or the inner space of a balaclava.

9. The breathing apparatus according to claim 1, wherein the self-contained breathing apparatus, the filter-ventilation unit and the head unit are arranged in the inner space of a protective suit which is provided with at least one passage of ambient air into the filter-ventilation unit and which is provided with a one-way exhalation valve of the suit.

10. A method of controlling the breathing apparatus according to claim 1, in which the cooperation of the self-contained breathing apparatus with the filter-ventilation unit in the inner space of the head unit is controlled, wherein the self-contained breathing apparatus delivers a controlled stream (S₁) of autonomous breathing gas into the inner space of the head unit and the filter-ventilation unit feeds a steady stream (S₂) of filtered air into the inner space of the head unit together to generate a breath-in stream (S₃) of the breathing gas/air in the inner space of the head unit-Heat-the steady stream (S₂) of the filtered air into the inner space of the head unit during the operation of the filter-ventilation unit keeps the outlet of the self-contained breathing apparatus closed when the pressure (p₁₅) of the steady stream (S₂) of the filtered air at the outlet of the self-contained breathing apparatus is higher than the set switching pressure (p_{S}) of the self-contained breathing apparatus, wherein when the pressure (p₁₅) of the steady stream (S₂) of the filtered air at the outlet of the self-contained breathing apparatus drops below the set switching pressure (p_{S}), the outlet of the self-contained breathing apparatus opens automatically and without user intervention, and the stream (S1) of the autonomous breathing gas is momentarily added to the stream (S2) of the filtered air in the inner space of the head unit, thereby autonomously and without intervention creating a breath-in stream (S3) of the breathing gas/air from the mixture of the two streams (S1, S2) in the inner space of the head unit.
